(19) United States
(12) Patent Application Publication
(10) Pub. No.: US 2013/0119698 A1
(43) Pub. Date: May 16, 2013

(54) FRICTION CONTROL IN HINGE ASSEMBLY

(71) Applicants: Brad F. PATZER, Barrie (CA); Michael D.J. SMITH, Aurora (CA); Mark BATTISTON, Toronto (CA); Murray DOBSON, Nobleton (CA)

(72) Inventors: Brad F. PATZER, Barrie (CA); Michael D.J. SMITH, Aurora (CA); Mark BATTISTON, Toronto (CA); Murray DOBSON, Nobleton (CA)

(73) Assignee: Ventra Group, Inc., Bradford (CA)

(21) Appl. No.: 13/295,859

(22) Filed: Nov. 14, 2011

(51) Int. Cl. E05D 7/04; B21D 53/40

(52) U.S. Cl. 296/146.12; 29/11

(57) ABSTRACT

A vehicle hinge assembly including a first hinge member mounted to a vehicle body or a vehicle closure panel and a second hinge member mounted to the other of the vehicle body or the vehicle closure panel. A first contact member is fixed to the first hinge member and a second contact member is fixed to the second hinge member. The first contact member and the second contact member have first and second surfaces, respectively, that frictionally engage each other. The first contact member and the second contact member are arranged between the first hinge member and the second hinge member such that relative motion of the vehicle closure panel between an open position and a closed position causes relative frictional motion between the first contact member and the second contact member to provide a resistance for controlling the movement of the vehicle closure member.

### FIELD OF THE INVENTION

The present invention relates to a hinge assembly that provides controlled pivotal movement of a vehicle closure member relative to a vehicle body.

### BACKGROUND

Vehicle closure members, such as trunk lids, of a vehicle are pivotally connected to a vehicle body via hinge assemblies. The hinge assemblies enable the vehicle closure members to be pivoted between open and closed positions. To control the motion of the vehicle closure members during pivoting between the closed and open positions and to support the vehicle closure member at the opened state, the hinge assemblies typically include various components, such as links, rollers, torque rods, springs, and various other components that provide resilience and/or friction. However, these hinge assemblies require many components, and thus may be more costly to manufacture and may be prone to failure, stress, and wear. Other hinge assemblies that include fewer components may not provide consistent friction/torque throughout the range of motion of the vehicle closure member during movement between the open and closed positions.

One or more embodiments of the present invention endeavor to provide various improvements over known hinge assemblies.

### SUMMARY OF THE INVENTION

One or more embodiments of the present invention provides for a vehicle hinge assembly including a first hinge member constructed to be mounted to one of a vehicle body and a vehicle closure panel and a second hinge member constructed to be mounted to the other of the vehicle body and the vehicle closure panel. The second hinge member is pivotally connected to the first hinge member. The hinge assembly further includes a first contact member fixed to the first hinge member and a second contact member fixed to the second hinge member. The first contact member has a first surface and the second contact member has a second surface. The first contact member and the second contact member are arranged with the first and second surfaces frictionally engaged such that relative motion of the vehicle closure panel between an open position and a closed position causes relative motion between the first contact member and the second contact member to provide a frictional resistance for controlling the movement of the vehicle closure member.

One or more embodiments of the present inventor provides for a method of assembling a vehicle hinge assembly. The method includes connecting a first contact member having a first surface to a first hinge member. The first hinge member is constructed and arranged to be mounted to one of a vehicle body and a vehicle closure panel. The method further includes connecting a second contact member having a second surface to a second hinge member. The second hinge member is constructed and arranged to be mounted to the other of the vehicle body and the vehicle closure panel. The method also includes pivotally connecting the first hinge member and the second hinge member such that the second surface frictionally engages the first surface and relative motion of the vehicle closure panel between an open position and a closed position causes relative motion between the first contact member and the second contact member to provide a frictional resistance for controlling the movement of the vehicle closure member.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment, the structural components illustrated herein can be considered drawn to scale. It is to be expressly understood, however, that the drawings are for the purpose of illustration and description only and are not a limitation of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

FIG. 1 is a perspective view of a hinge assembly connected to a vehicle body and a vehicle closure member of a vehicle in accordance with an embodiment;

FIG. 2 is a cross sectional side view of the hinge assembly in accordance with the embodiment shown in FIG. 1.

FIG. 3 is a detailed view of another embodiment of the hinge assembly, with portions of the first hinge member removed to better reveal other portions of the hinge assembly;

FIG. 4 is an exploded view of the hinge assembly in accordance with the embodiment of FIG. 3;

FIG. 5 is a perspective view of the hinge assembly in a first position, with a portion of a first hinge member removed to better reveal portions of a second hinge member, in accordance with the embodiment shown in FIG. 3;

FIG. 6 is a perspective view of the hinge assembly in a second position, with a portion of the first hinge member removed to better reveal portions of the second hinge member, in accordance with the embodiment of FIG. 3;

FIG. 7 is a detailed view of yet another embodiment of the hinge assembly, with portions of the first hinge member removed to better reveal other portions of the hinge assembly;

FIG. 8 is a detailed view of a contact member of the embodiment of the hinge assembly shown in FIG. 7;

FIG. 9 is a detailed view of a portion of a second contact member connected to a second hinge member of the embodiment of the hinge assembly shown in FIG. 7; and

FIG. 10 is a detailed view of a portion of the embodiment of the hinge assembly shown in FIG. 7, with a first contact member connected to a first hinge member shown.

### DETAILED DESCRIPTION OF EMBODIMENTS OF THE INVENTION

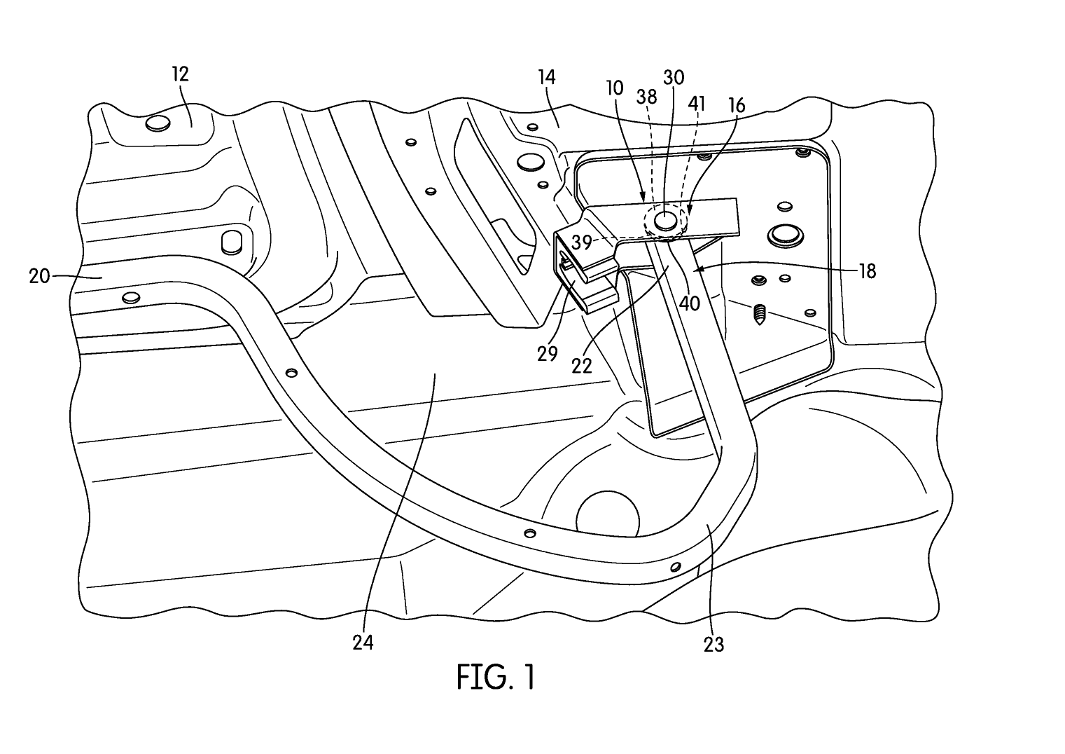

FIG. 1 illustrates an embodiment of a vehicle hinge assembly 10 that provides pivotal movement of a vehicle closure member 12, taking the form of a trunk lid in this embodiment, relative to a vehicle body 14. The vehicle closure member 12 pivots about a horizontal axis defined by the hinge axis of the hinge assembly 10. It should be appreciated that the hinge assembly 10 may be used to provide pivotal movement of other types of closure members, such as, just for example, an engine lid or a door.

In the embodiment shown in FIG. 1, the hinge assembly 10 includes a first hinge member 16 constructed and arranged to be connected to the vehicle body 14 and a second hinge member 18 constructed and arranged to be connected to the vehicle closure member 12. In this embodiment, the first hinge member 16 takes the form of a bracket. The first and second hinge member 16, 18 may be pivotally connected to each other so as to enable the vehicle closure member 12 to pivot between a closed position wherein access to the contents of an interior space 24 of the vehicle is prevented and an open position wherein access to the contents of the interior space 24 of the vehicle is permitted.

In this embodiment, the hinge assembly 10 includes a first contact member 38 having a first contact surface 39 and a second contact member 40 having a second contact surface 41. The illustrated contact surfaces 39, 41 are disposed on the axial faces of the contact members 38, 40 and have a circular shape with a hole in the middle for the pivot pin 30. The first contact member 38 and the second contact member 40 may be disposed between the first hinge member 16 and the second hinge member 18. The first contact member 38 is fixedly connected to the first hinge member 16 and the second contact member 40 is connected to the second hinge member 18. In one embodiment, the first contact member 38 is welded to the first hinge member 16 and the second contact member 40 is welded to the second hinge member 18. In one embodiment, the first and second contact members 38, 40 are arranged between the first hinge member 16 and the second hinge member 18 such that the contact surfaces 39, 41 frictionally engage each other and relative motion of the vehicle closure panel 12 between a closed position and an open position causes relative motion between the first contact member 38 and the second contact member 40 to provide a resistance for controlling the movement of the vehicle closure member 12.

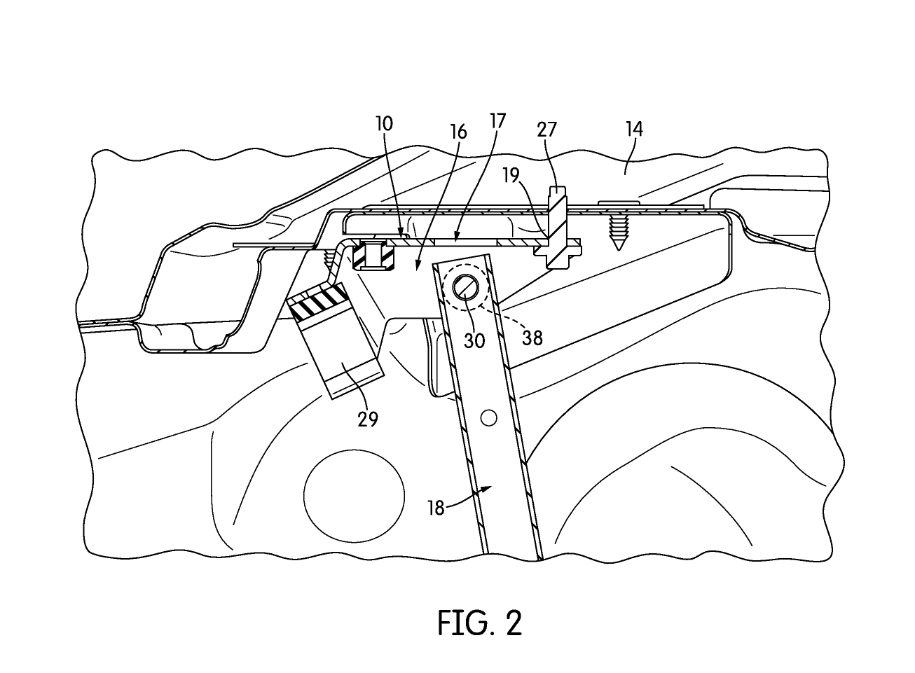

FIG. 2 shows a side view of the embodiment of the hinge assembly 10 shown in FIG. 1. As shown in FIG. 2, the first hinge member 16 may include an attachment portion 17 having openings 19 constructed and arranged to receive an attachment structure 27, such as screws, pins, bolts, or other attachment mechanisms to attach the first hinge member 16 to the vehicle body 14. The first hinge member 16 may also be provided with a generally U-shaped contact portion 29 constructed and arranged to receive and contact a portion of the second hinge member 18 when the second hinge member 18 is rotated upwards to the second position. The contact portion 29 may include a lining made of resilient materials, such as rubber, plastic, foam, or other materials.

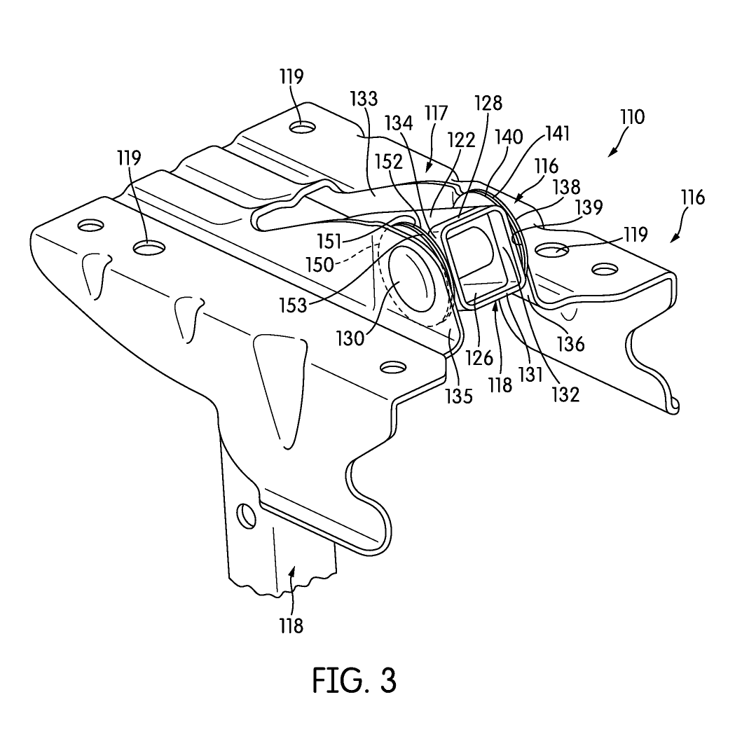

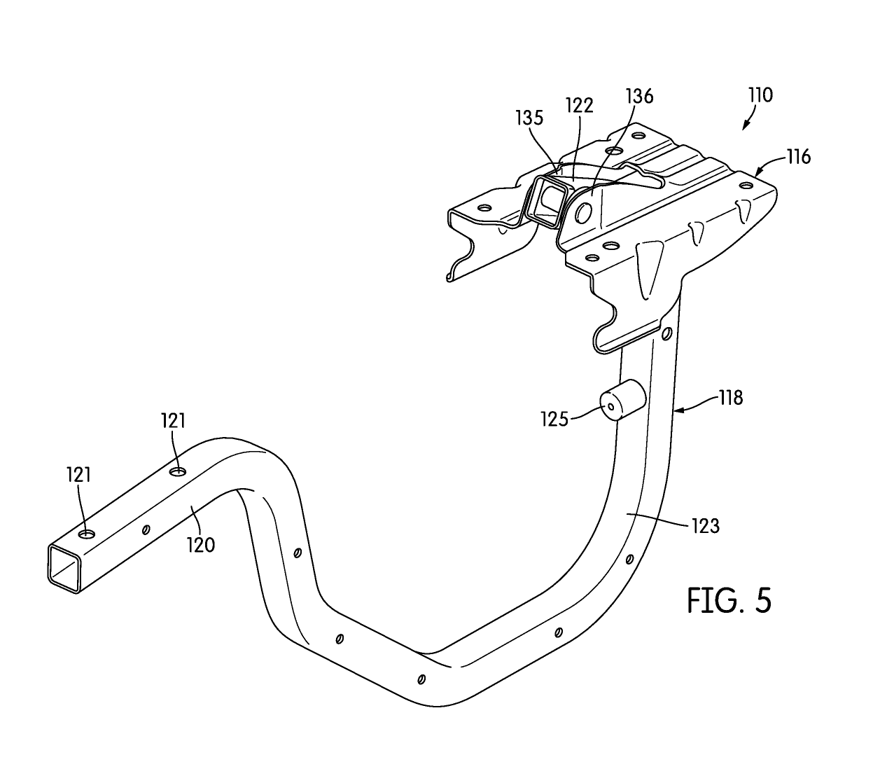

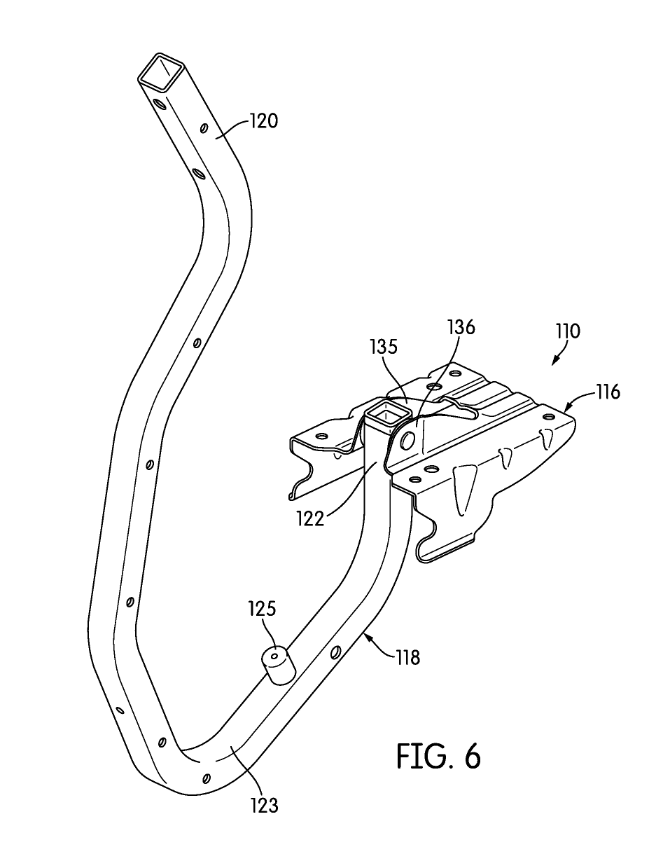

FIG. 3 shows another embodiment of the hinge assembly 110. The hinge assembly 110 may be attached to the vehicle closure member 12 and the vehicle 14 in a similar manner as the hinge assembly 10 described above. Some of the components of the hinge assembly 110 may be similar to the components of the hinge assembly 10 described above. For example, the hinge assembly 110 includes a first hinge member 116 constructed and arranged to be connected to the vehicle body 14 and a second hinge member 118 constructed and arranged to be connected to the vehicle closure member 12. Accordingly, when the vehicle closure member 12 is moved between the closed and open positions, the second hinge member 118, which is connected to the vehicle closure member 12, pivots relative to the first hinge member 116 between a first position (see for example, FIG. 5) and a second position (see for example, FIG. 6), respectively.

In this embodiment, the second hinge member 118 takes the form of a tubular “gooseneck”-shaped elongated structure (see FIG. 5 for a better view). The first and second hinge members 116, 118 may have other shapes in other embodiments. The second hinge member 118 includes a first portion 120 (see FIG. 5) for connecting to the vehicle closure member 112 and a second portion 122 for connecting to the second hinge member 118. As shown in FIG. 5, the first portion 120 of the second hinge member 118 may be provided with openings 121 that are constructed and arranged to receive screws, pins, bolts, or other attachment mechanisms to attach the second hinge member 18 to the vehicle closure member 12. A curved intermediate portion 123 may be provided between the first portion 120 and the second portion 122 to enable an edge of the vehicle closure member 12 to move away from the vehicle body 14 in a spaced relationship upon movement of the vehicle closure member 12 from the closed position to the open position.

In one embodiment, for example as shown in FIG. 5, the curved intermediate portion 123 may be provided with a contact structure 125, which may be made of rubber, foam, or other resilient materials, that contacts a portion of the vehicle body 14 when the second hinge member 118 is pivoted fully to the second position (i.e., when the vehicle closure member 12 is moved fully to the open position). This contact structure 125 may also be referred to as a bumper. The contact structure 125 is located at the inner (i.e., the concave) side of the curved portion 123.

The first and second hinge members 116, 118 may be made of metal and may be manufactured via stamping, hydroforming, or other manufacturing methods. However, it should be appreciated that the first and second hinge members 116, 118 may be made of other materials or a combination of materials in other embodiments and/or may be manufactured in other ways. It should also be appreciated that in other embodiments, the location of the first hinge member 116 and the location of the second hinge member 118 may be interchanged. That is, the first hinge member 116 may be connected to the vehicle closure member 12 and the second hinge member 118 may be connected to the vehicle body 14.

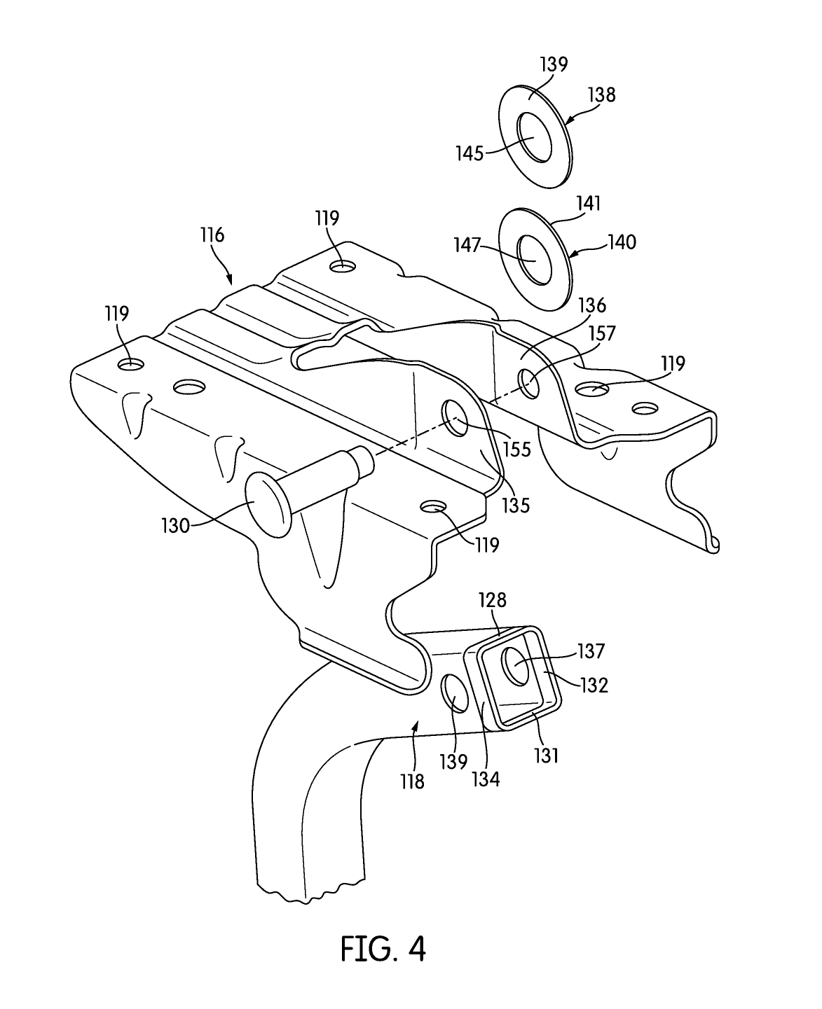

Referring back to FIG. 3, the second hinge member 118 is a tubular structure having a hollow interior 126 and a rectangular or square cross section. The cross section of the second hinge member 118 may be uniform through at least a portion of the length of the second hinge member 118. It should be appreciated that the second hinge member 118 may have other cross sectional shapes and may vary in size in other embodiments. In this embodiment, the second hinge member 118 includes a top portion 128 and a bottom portion 131 that are generally orthogonal to side portions 132, 134. Top, bottom, and side portions 128, 131, 132, 134 may be walls. Side walls 132, 134 may be provided with openings 137, 149 (see FIG. 4), respectively, constructed and arranged to receive a pivot pin 130. Side walls 135, 136 of the first hinge member 116 may also define a receiving space 133 therebetween that is constructed and arranged to receive at least a portion of the second hinge member 118. Openings 155, 157 (see FIG. 4) may be also be formed in side walls 135, 136, respectively, of the first hinge member 16 and may be constructed and arranged to receive the pivot pin 130. In one embodiment, the pivot pin 130 may be made of steel and may be heat treated. It should be appreciated that the pivot pin 130 may be made of other materials in other embodiments. The pivot pin 130 may define a pivot axis in which the second hinge member 118 pivots relative to the first hinge member 116.

The hinge assembly 110 is configured to provide resistance to control the movement of the vehicle closure member 12 between the closed and open positions. In one embodiment, the resistance slows the rate at which the vehicle closure member 12 is moved from the closed position to the open position. In one embodiment, the hinge assembly 110 enables the vehicle closure member 12 to be retained at a selected position between the closed and fully open positions. That is, in such an embodiment, the hinge assembly 110 is configured to enable the vehicle closure member 12 to remain located at a selected angular position relative to the vehicle body 14 without additional support.

Referring back to FIG. 3, the hinge assembly 110 includes a first contact member 138 having a first contact surface 139 and a second contact member 140 having a second contact surface 141. The illustrated contact surfaces 139, 141 are disposed on the axial faces of the contact members 138, 140 and have a circular shape with a hole in the middle for the pivot pin 130. The first contact member 138 and the second contact member 140 may be disposed between the first hinge member 116 and the second hinge member 118. The first contact member 138 is fixedly connected to the first hinge member 116 and the second contact member 140 is connected to the second hinge member 118. In one embodiment, the first contact member 138 is welded to the first hinge member 116 and the second contact member 140 is welded to the second hinge member 118. It should be appreciated that the first contact member 138 may be fixed or secured to the first hinge member 116 and the second contact member 140 may be fixed or secured to the second hinge member 140 via other attachment or connection mechanisms. As shown in FIG. 4, openings 145, 147) may be provided in the first contact member 138 and the second contact member 140, respectively. The openings in the first contact member 138 and the second contact member 140 may be constructed and arranged to receive the pivot pin 130 when the hinge assembly 110 is assembled. In one embodiment, the first contact member 138 and the second contact member 140 comprise circular washers or disks. In one embodiment, the first contact member 138 and the second contact member 140 may have the same size and the same circumference (i.e., the first circumference of the first contact member 138 is the same as the second circumference of the second contact member 140). In one embodiment, the first and second contact members 138, 140 each has an outside diameter of about 25 mm. Alternatively, in other embodiments, the first and second contact member 138, 140 may have different sizes. The first and second contact members 138, 140 may be made of cast iron, brass, phosphor bronze, aluminum alloy, copper lead alloy, white metal, cadmium alloy, lead copper, lead bronze, iron, other types of metals, plastic, compressible elastic material, such as rubber, other materials, or a combination of materials.

In the illustrated embodiment, the contact members 138, 140 comprise full circle washers. However, according to alternative embodiments, the arcs covered by the contact members 138, 140 may be less than 360 degree full circles.

In one embodiment, for example as shown in FIG. 3, the first and second contact members 138, 140 are arranged between the first hinge member 116 and the second hinge member 118 such that the contact surfaces 139, 141 frictionally engage each other and relative motion of the vehicle closure panel 12 between a closed position and an open position causes relative motion between the first contact member 138 and the second contact member 140 to provide a resistance for controlling the movement of the vehicle closure member 12. Accordingly, pivotal movement of the first hinge member 116 relative to the second hinge member 118 causes friction to be created between the first contact member 138 and the second contact member 140. The friction may be utilized to slow the descent of the vehicle closure member 12 to the closed position. In some embodiments the friction may prevent the descent of the vehicle closure member 12 so as to support the vehicle closure member 12 at various angular locations relative to the vehicle body 14. Thus, in some embodiments, the first contact member 138 and the second contact member 140 may produce friction within the hinge assembly 110 so that the hinge assembly 110 may function as a friction hinge assembly that enables the vehicle closure member 12 to be positioned at a selected angular position relative to the vehicle body. It should be appreciated that the first and second contact members 138, 140 of the hinge assembly 110 may have a similar configuration and arrangement as the first and second contact members 138, 140 of the hinge assembly 110 and may function in a similar manner.

The rounded or circular shape of the first and second contact member 138, 140 enables the contact area between the contact surfaces 139, 141 to remain uniform over a pivotal range of the hinge assembly 110 (i.e., the pivotal range spanning the open and closed positions of the hinge assembly 110). Thus, the contact area between the first and second contact members 138, 140 may be consistent and uniform during movement of the vehicle closure member 12 between the open and closed positions. The uniform contact surface area between the first and second contact members 138, 140 may create a uniform clamp load. Without the contact members 138, 140 between the first hinge member 116 and the second hinge member 118, the contact surface between the first hinge member 116 and the second hinge member 118 may change through the rotation, which may result in a changing clamp load. However, by arranging the first and second contact members 138, 140 between the first and second hinge member 116, 118, the first and second contact surface 138, 140 may provide a consistent clamp load and thus, a consistent frictional force. The force of friction may be calculated using the following equation:

F_{f}=μ×Fₙ where F_{f} is the force of friction, μ is the material coefficient of friction and Fₙ is the normal force exerted by each surface on the other. The uniform contact surface between the first and contact members 138, 140 enable the normal force (Fₙ) to be constant. More specifically, because Fₙ is a function of pressure divided by area (P/A), having the surface area coefficient remain constant for a constant pressure enables Fₙ to be constant.

The uniform contact surface may reduce the amount of variation in friction produced in the hinge assembly 110 during the movement of the vehicle closure member 12 between the open and closed positions. Accordingly, the range of the minimum and maximum forces may be minimized. The amount of friction, and thus the amount of torque and resistance provided by the hinge assembly 110, may be varied for different embodiments based on the size of the contact surface between the first contact member 138 and the second contact member 140, the sizes of the first contact member 138 and the second contact member 140, the thickness of the first contact member 138 and the second contact member 140, the amount of pressure or frictional force between the first contact member 138 and the second contact member 140, and/or other factors. To vary the amount of compression between the first contact member 138 and the second contact member 140, the thickness of the first and second contact members 138, 140 may be varied and/or the amount of space between the side portions 132, 134 of the second hinge member 118 and the side walls 135, 136 of the first hinge member 116 may be varied.

According to various embodiments, the contact surfaces 139, 141 may comprise textures and/or materials that facilitate the desired frictional resistance. For example, a rough surface texture may be employed to increase friction. According to various embodiments, the contact members 138, 140 are arranged such that the static and/or dynamic friction between their respective first and second contact surfaces 139, 141 varies by less than 50%, 40%, 30%, 20%, 15%, 10%, and/or 5% over a pivotal range of the hinge assembly 110.

In one embodiment, at least one of the first contact member 138 and the second contact member 140 may also rotate along an axis created by the pivot pin 130 relative to the pivot pin 130 itself during movement of the vehicle closure member 12 between the open and closed positions. Accordingly, the friction between the pivot pin 130 and the first contact member 138 or the second contact member 140 may also produce resistance for controlling the movement of the vehicle closure member 12 between the open and closed positions. In one embodiment, the torque produced by the contact between the pivot pin 130 and the first contact member 138 or the second contact member 140 may also be utilized to support the vehicle closure member 12 at a selected position between the closed and fully open positions. In such embodiments, the thickness of the first contact member 118 or the second contact member 130 may be varied to vary the amount of torque produced during the pivoting movement. Thus, the contact between the first contact member 138 and the second contact member 140 and optionally the contact between the pivot pin 130 and first contact member 138 or the second contact member 140 may produce resistance for controlling the movement of the vehicle closure member between the open and closed positions. In other words, in some embodiments, resistance may be created to control the amount of force necessary to move the vehicle closure member 12 between the open and closed positions and to enable the vehicle closure member 12 to remain at an angular location relative to the vehicle body 14.

FIG. 5 shows the hinge assembly 110 in the first position. The vehicle closure member 12 is typically in the closed position relative to the vehicle body 14 when the hinge assembly 110 is in the first position. To move the vehicle closure member 12 towards the open position, the hinge assembly 14 is moved to the second position as shown in FIG. 6 by pivoting the second hinge member 118 relative to the first hinge member 116. During movement of the vehicle closure member 12 towards the open position and thus, during the pivoting of the second hinge member 118 relative to the first hinge member 116, the first contact member 138, which is connected to the first hinge member 116, and the second contact member 140, which is connected to the second hinge member 18, are in contact with each other via their contact surfaces 139, 141 so as to produce friction. In one embodiment, the constant friction torque produced by the hinge assembly 110 may be at least equal to or greater than the opposing torque imposed by gravity (e.g., the weight of the vehicle closure member 12) to retain a selected position of the vehicle closure member 12 and to prevent the vehicle closure member 12 from descending to the closed position. Other factors may be taken into consideration when determining the constant friction torque required to position the vehicle closure member 12, such as, just for example, the vibration that may be generated by the vehicle when the engine of the vehicle is on, and force that may be exerted on the vehicle closure member 12 due to wind.

In some embodiments, for example as shown in FIG. 3, the hinge assembly 110 may also include a third and fourth contact members 150, 152 with third and fourth contact surfaces 151, 153 that have a similar configuration as the first and second contact members 138, 140 and a fourth contact member 152 having a similar configuration as the second contact member 140. In some embodiments, the third and fourth contact members may have the same or different shapes and sizes as the first and second contact members 138, 140, respectively. The third contact member 150 may be connected to the first hinge member 16 and the fourth contact member 152 may be connected to the second hinge member 118 in the same or similar manner as the members 138, 140 are connected to the hinge members 116, 118. However, the third and fourth contact members 150, 152 may be connected to the side wall 135 of the first hinge member 116 and the side portion 134 of the second hinge member 118, respectively (e.g., on the other side of the hinge member 118 as the first and second contact members 138, 140 are connected). It should be appreciated that in some embodiments, the hinge assembly 110 may include only one pair of the contact members 138, 140 and contact members 150, 152. That is, in some embodiments, the hinge assembly 10, 110 may include either first and second contact members 138, 140 or the third and fourth contact members 150, 152. Alternatively, in some embodiments, the hinge assembly 110 may include both pairs of contact members 138, 140, 150, and 152.

Embodiments of the hinge assembly 110 may provide the following characteristics with the forces measured in Newtons:

4 Piece study with Welded Washers

| | | | | Average |
|---|---|---|---|---|
| Sample # | Min Force | Max Force | Range | Force |
| 1 | 5.8 | 10.4 | 4.6 | 8.1 |
| 2 | 10.9 | 13.1 | 2.2 | 12.0 |
| 3 | 8 | 12.7 | 4.7 | 10.4 |
| 4 | 7.4 | 13.6 | 6.2 | 10.5 |

However, it should be appreciated that these characteristics are not intended to be limiting, and the characteristics may vary for other embodiments of the hinge assembly 110.

To assemble the hinge assembly 110, the first contact member 38 may be connected to the first hinge member 16 (e.g., via welds, rivets, screws, bolts, glue, etc.). The second contact member 140 may be similarly connected to the second hinge member 118. The second portion 122 of the second hinge member 118 and the second contact member 140 may then be placed into the receiving space 133 defined between the side portions 132, 134 of the first hinge member 116 such that the openings of the first hinge member 116, the second hinge member 118, the first contact member 138, and the second contact member 140 are aligned. The pivot pin 130 may then be inserted through the aligned openings of the first hinge member 116, the second hinge member 118, the first contact member 138, and the second contact member 140 to pivotally connect the first hinge member 116 and the second hinge member 118. Accordingly, the first contact member 38 and the second contact member 140 creates a contact area between the contact surfaces 139, 141 that produces resistance during pivoting movement of the second hinge member 118 relative to the first hinge member 116.

In embodiments having third and fourth contact members 150, 152, the third and fourth contact members 150, 152 may be similarly connected to the first and second hinge members 116, 118, respectively, and assembled in a similar manner as the first and second contact members 138, 140 described above. In embodiments having four contact members, the first and second contact members 138, 140 may be arranged between either 1) the side wall 136 of the first hinge member 116 and the side portion 132 of the second hinge member 118 or 2) between the side wall 135 of the first hinge member 116 and the side portion 134 of the second hinge member 118. The third and fourth contact members may then be arranged between the other of either the side wall 136 of the first hinge member 116 and the side portion 132 of the second hinge member 18 or between the side wall 135 of the first hinge member 116 and the side portion 34 of the second hinge member 118.

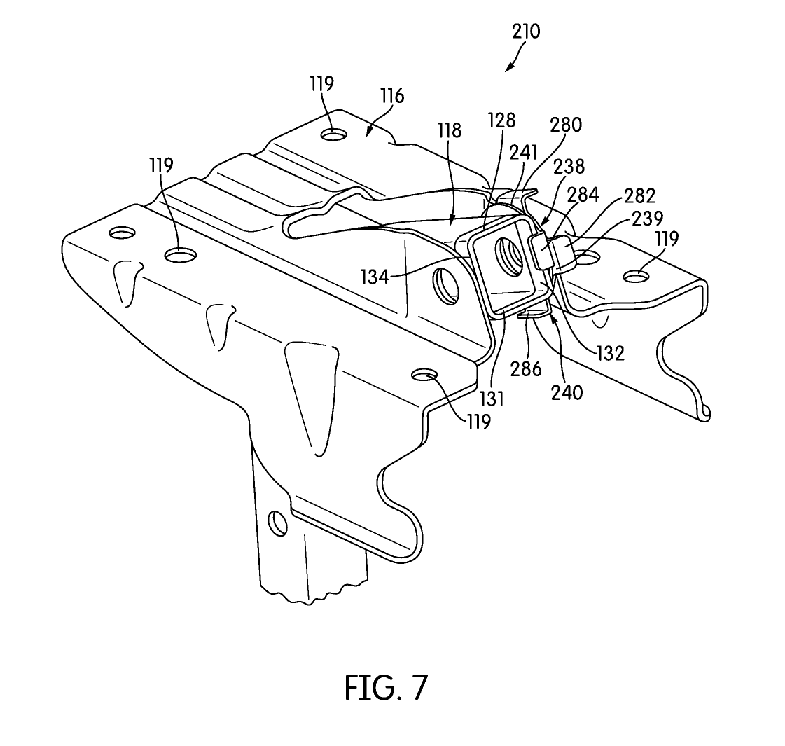

FIG. 7 shows another embodiment of the hinge assembly 210. In this embodiment, the first hinge member 116 and the second hinge member 118 may be similarly constructed as the first hinge member 116 and the second hinge member 118 of the hinge assembly 110 described above, and thus will be labeled in a similar manner. Accordingly, similar components of the first hinge member 116 and the second hinge member 118 of the hinge assembly 210 will also be labeled in a similar manner as the components of the first hinge member 116 and the second hinge member 118 of the hinge assembly 110. In this embodiment, the hinge assembly 210 includes first and second contact members 238, 240 constructed and arranged to provide frictional resistance for controlling the movement of the vehicle closure member. The first contact member 238 is constructed and arranged to be connected to the first hinge member 116 and the second contact member 240 is constructed and arranged to be connected to the second hinge member 118.

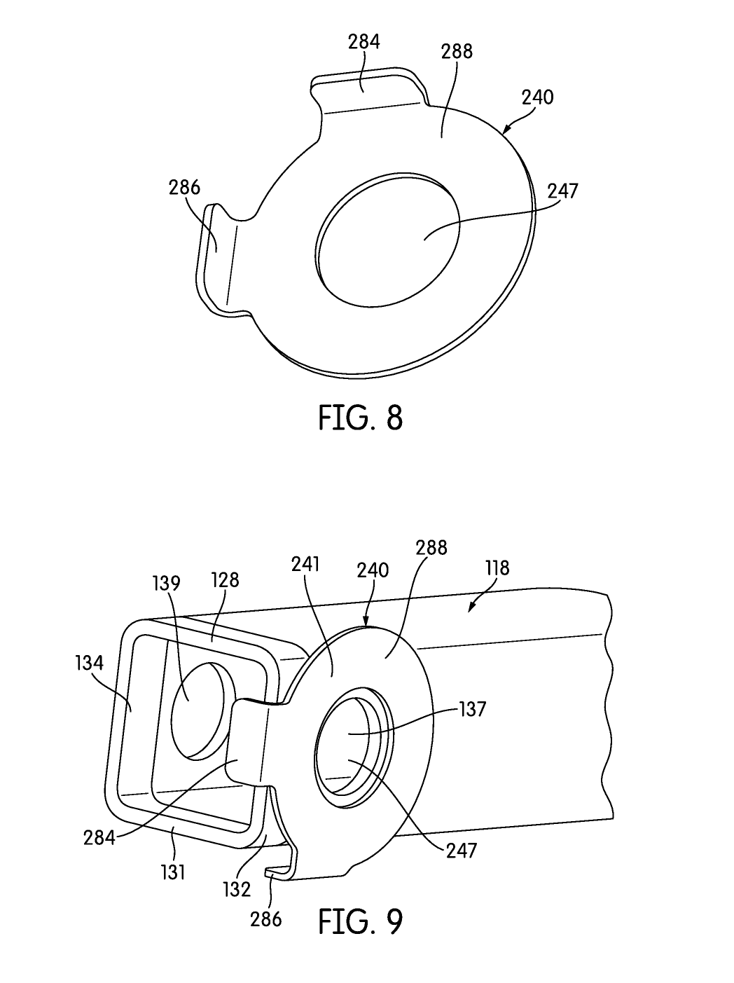

The first and second contact members 238, 240 may have similar construction as one another. FIG. 8 shows in more detail the second contact member 240. In this embodiment, the second contact member 240 includes a main body 288, a first protrusion 284, and a second protrusion 286. The protrusions 284, 286 may take the form of tabs constructed and arranged to extend at a predetermined angle (e.g., 90 degrees or any other degrees) from the main body 288. The protrusions 284, 286 may extend from various locations of the main body 288. For example, the main body 288 may be circular and thus, the protrusions 284, 296 may be located 90 degrees relative to each other around the circumference of the main body 288. However, it should be appreciated that the location of the protrusions 284, 286 may vary in other embodiments.

FIG. 9 shows the second contact member 240 connected to the second hinge member 118. In this embodiment, the first protrusion 284 is constructed and arranged to be parallel to a plane defined by a cross section of the second hinge member 118. The second protrusion 286 is constructed and arranged to be parallel to a plane defined by the bottom portion 132 of the second hinge member 118. Accordingly, the first and second protrusions 284, 286 may be constructed and arranged to prevent rotation of the second contact member 240 relative to the second hinge member 118. A second contact surface 241 is provided on the main body 288 and is constructed and arranged to contact at least a portion of the first contact member 238.

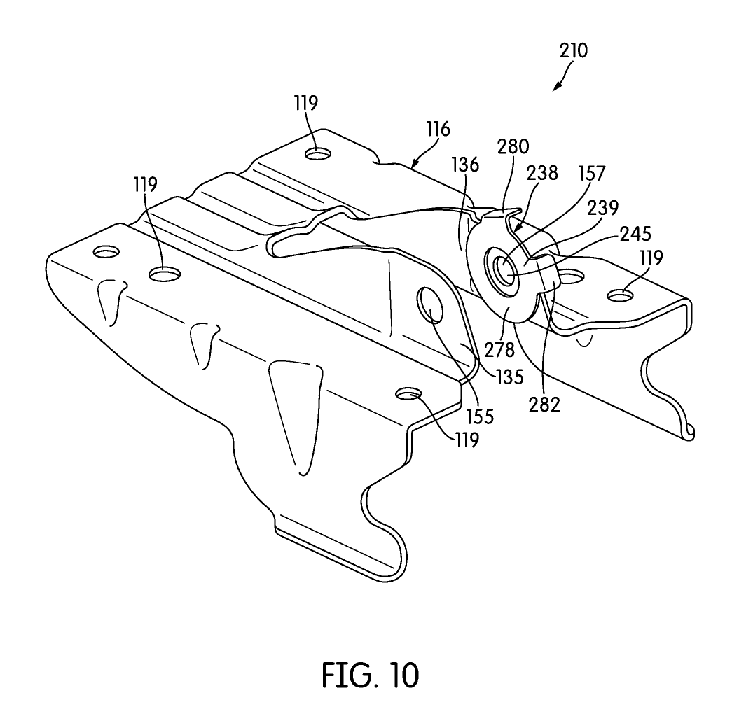

FIG. 10 shows the first contact member 238 connected to the first hinge member 116. As mentioned above, the first contact member 238 may have a similar construction as the second contact member 240. Accordingly, the first contact member 238 includes first and second protrusions 280, 282. The protrusions 280, 282 may be constructed and arranged to extend from a main body 278 of the first contact member 238. The protrusions 280, 282 may be constructed and arranged to abut against or contact an edge of the side wall 136 of the first hinge member 116 to prevent rotation of the first contact member 238 relative to the first hinge member 116. The main body 278 of the first contact member 238 includes the first contact surface 239 constructed and arranged to contact the second contact surface 241 of the second contact member 240.

Referring back to FIG. 7, the hinge assembly 210 is arranged such that the first contact surface 239 of the first contact member 238 is constructed and arranged to contact the second contact surface 241 of the second contact member 240. That is, the first and second contact members 238, 240 are arranged between the first hinge member 116 and the second hinge member 118 such that the contact surfaces 239, 241 frictionally engage each other and relative motion of the vehicle closure panel 12 between a closed position and an open position causes relative motion between the first contact member 238 and the second contact member 240 to provide a resistance for controlling the movement of the vehicle closure member 12. Accordingly, the frictional resistance provided by the first and second contact members 238, 240 of the hinge assembly 210 may be similar to the frictional resistance provided by the first and second contact members 138, 140 of the hinge assembly 110. It should be appreciated that additional contact members may be provided (e.g., a third or fourth contact member). Furthermore, the hinge assembly 210 may operate in a similar manner as the hinge assembly 110 described above.

In some embodiments, the hinge assembly 10, 110, 210 may optionally include springs or resilient structures or may be connected to springs or other resilient structures to facilitate the movement of the vehicle closure member 12 from the closed position to the open position. In other embodiments, the vehicle closure member 12 may have springs or other resilient structures that initially “pop” or move the vehicle closure member 12 to a predetermined angular position relative to the vehicle body 14 when moving the vehicle closure member 12 away from the closed position. Accordingly, a user may then push the vehicle closure member 12 against the resistance provided by the hinge assembly 10, 110, 210 and the weight of the vehicle closure member 12 to a selected position between the closed and fully open positions. According to an alternative embodiment, such springs may counteract the force of gravity on the vehicle closure member 12. The contact members 38, 40, 138, 140, 238, 240 then help to maintain the hinge assembly 10, 110, 210 and vehicle closure member 12 in the position it is placed by a user.

The foregoing illustrated embodiments have been provided solely for the purpose of illustrating the structural and functional principles of the present invention, and it is not intended to be limiting. To the contrary, the present invention is intended to encompass all variables, modifications, alterations, substitutions, and equivalents within the spirit and scope of the following claims.

What is claimed:

1. A vehicle hinge assembly comprising:
a first hinge member constructed to be mounted to one of a vehicle body and a vehicle closure panel;
a second hinge member constructed to be mounted to the other of the vehicle body and the vehicle closure panel, the second hinge member being pivotally connected to the first hinge member;
a first contact member fixed to the first hinge member, the first contact member having a first surface;
a second contact member fixed to the second hinge member, the second contact member having a second surface,
wherein the first contact member and the second contact member are arranged with the first and second surfaces frictionally engaged such that relative motion of the vehicle closure panel between an open position and a closed position causes relative motion between the first contact member and the second contact member to provide a frictional resistance for controlling the movement of the vehicle closure member.

2. The vehicle hinge assembly of claim 1, wherein the first contact member and the second contact member are arranged such that a static friction between their respective first and second surfaces varies by less than 20% over a pivotal range of the hinge assembly.

3. The vehicle hinge assembly of claim 2, wherein the static friction varies by less than 10% over the pivotal range of the hinge assembly.

4. The vehicle hinge assembly of claim 1, wherein the first contact member and the second contact member are arranged to create a uniform contact surface between their respective first and second surfaces over a pivotal range of the hinge assembly.

5. The vehicle hinge assembly of claim 1, wherein the first surface covers an arc having the same circumference as an arc covered by the second circumference.

6. The vehicle hinge assembly of claim 1, further comprising a third contact member fixed to the first hinge member, the third contact member having a third surface.

7. The vehicle hinge assembly of claim 6, further comprising a fourth contact member fixed to the second hinge member, the fourth contact member having a fourth surface that frictionally engages the third surface.

8. The vehicle hinge assembly of claim 7, wherein the third contact member and the fourth contact member are arranged such that a static friction between their respective third and fourth surfaces varies by less than 20% over a pivotal range of the hinge assembly.

9. The vehicle hinge assembly of claim 1, wherein the second hinge member is tubular.

10. The vehicle hinge assembly of claim 1, wherein the first and second contact members comprise circular washers.

11. The vehicle hinge assembly of claim 1, in combination with a vehicle comprising:
a vehicle body; and
a vehicle closure member,
wherein the first hinge member is mounted to the one of the vehicle body and the vehicle closure panel, and
wherein the second hinge member is mounted to the other of the vehicle body and the vehicle closure panel.

12. A method of assembling a vehicle hinge assembly, the method comprising:
connecting a first contact member having a first surface to a first hinge member, the first hinge member being constructed and arranged to be mounted to one of a vehicle body and a vehicle closure panel;
connecting a second contact member having a second surface to a second hinge member, the second hinge member being constructed and arranged to be mounted to the other of the vehicle body and the vehicle closure panel;
pivotally connecting the first hinge member and the second hinge member such that the second surface frictionally engages the first surface and relative motion of the vehicle closure panel between an open position and a closed position causes relative motion between the first contact member and the second contact member to provide a frictional resistance for controlling the movement of the vehicle closure member.

13. The method of claim 12, wherein the first surface covers an arc having the same circumference as an arc covered by the second circumference.

14. The method of claim 12, further comprising:
connecting a third contact member having a third surface to the first hinge member; and
connecting a fourth contact member having a fourth surface to the second hinge member,
wherein after the pivotal connecting, the third surface frictionally engages the fourth surface.

15. The method of claim 12, wherein the first and second contact members comprise circular washers.

16. The method of claim 12, wherein after the pivotal connecting, the first contact member and the second contact member are arranged such that a static friction between their respective first and second surfaces varies by less than 20% over a pivotal range of the hinge assembly.

17. The method of claim 12, wherein after the pivotal connecting, the first contact member and the second contact member are arranged to create a uniform contact surface between their respective first and second surfaces over a pivotal range of the hinge assembly.
